(19) United States
(12) Patent Application Publication
(10) Pub. No.: US 2005/0084627 A1
(43) Pub. Date: Apr. 21, 2005

(54) Springless trampoline with contrasting edge

(76) Inventor: Keith Vivian Alexander, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/755,028

(22) Filed: Jan. 9, 2004

(30) Foreign Application Priority Data
Oct. 15, 2003 (NZ) 528908

(51) Int. Cl. A41G 1/00; A01N 3/00

(52) U.S. Cl. 428/27

(57) ABSTRACT

A trampoline includes a flexible mat 1, a plurality of resiliently flexible rods 2 each having a lower end retained in a frame 3 of the trampoline and an upper end coupled to the periphery of the flexible mat 1, and a region of contrasting colour to the colour of mat about a peripheral portion of the mat at or adjacent the peripheral edge of the mat. The region of contrasting colour may be provided by one or more concentric circles 9, a sinuous line 12, a zig-zag 13, or a plurality of discrete by discrete non-continuous areas 14 of contrasting colour for example.

### FIELD OF INVENTION

The invention relates to a trampoline for sporting and/or recreational use which is soft-edged relative to conventional trampolines which support the mat of the trampoline via a solid peripheral frame and exposed springs between the frame and the mat.

### BACKGROUND

U.S. Pat. No. 6,319,174 discloses a form of soft-edged trampoline in which the mat of the trampoline is supported by a plurality of resiliently flexible rods received in a frame of the trampoline at the lower ends of the rods and coupled to the periphery of the bouncing mat of the trampoline at their upper ends, and which avoids the need for a solid frame about the exterior of the bouncing mat and exposed springs between the frame and periphery of the mat.

PCT International Application WO 03/043704 discloses a form of such a soft-edged trampoline in which the upper ends of the resiliently flexible rods are coupled to the periphery of the mat via fittings having a cavity on the underside of the fittings into which engage ball-shaped upper ends of the rods.

### SUMMARY OF THE INVENTION

The invention provides an improved or at least alternative form of such a soft-edged trampoline.

In this specification (including claims) the term “trampoline” is intended to extend to smaller trampolines commonly referred to as rebounders also, as well as larger trampolines of all sizes.

In broad terms in one aspect the invention comprises a trampoline including
a flexible mat,
a plurality of resiliently flexible rods each having a lower end retained in a frame of the trampoline and an upper end coupled to the periphery of the flexible mat, and
a region of contrasting colour to the colour of mat about a peripheral portion of the mat at or adjacent the peripheral edge of the mat.

In one form said region of contrasting colour may include a substantially continuous line or lines around said peripheral edge portion of the mat, such as a single line, a zig-zag line, a sinusoidal line and/or a multiple number of substantially continuous lines which may be concentric, around said peripheral edge portion of the mat.

### BRIEF DESCRIPTION OF THE DRAWINGS

Preferred forms of trampoline are described with reference to the accompanying drawings by way of example and without intending to be limiting, wherein:

FIG. 1 is a perspective view of a preferred form trampoline,

FIG. 2 is a side view of the trampoline of FIG. 1,

FIG. 3 is a plan view of the trampoline of FIGS. 1 and 2,

FIG. 4 is a close up or detail view of a part of the periphery of the mat of the trampoline of FIGS. 1 to 3,

FIG. 5 is a perspective view of a second preferred form trampoline,

FIG. 6 is a close up or detail view of a part of the periphery of the mat of the trampoline of FIG. 5,

FIG. 7 is a perspective view of a third preferred form trampoline,

FIG. 8 is a close up or detail view of a part of the periphery of the mat of the trampoline of FIG. 7,

FIG. 9 is a perspective view of a fourth preferred form trampoline,

FIG. 10 is a close up or detail view of a part of the periphery of the mat of the trampoline of FIG. 9,

FIG. 11 is a perspective view of a fifth preferred form trampoline,

FIG. 12 is a close up or detail view of a part of the periphery of the mat of the trampoline of FIG. 11,

FIG. 13 is a perspective view of a sixth preferred form trampoline, and

FIG. 14 is a close up or detailed view of a part of the periphery of the mat of the trampoline of FIG. 13.

### DETAILED DESCRIPTION OF PREFERRED FORMS

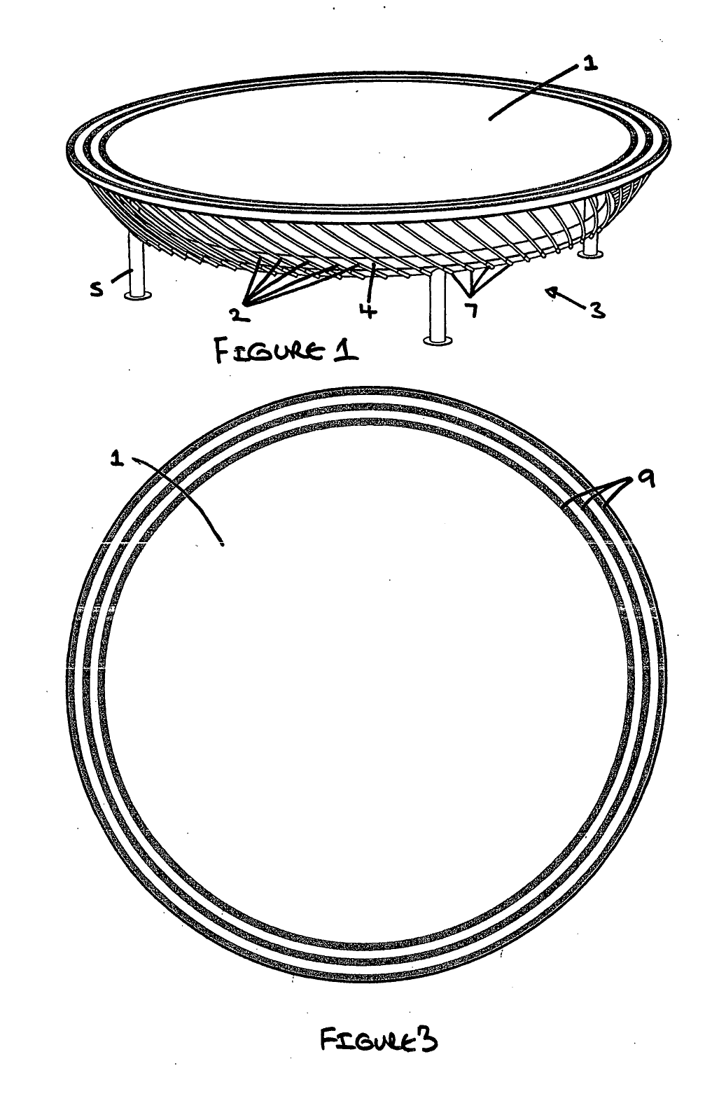

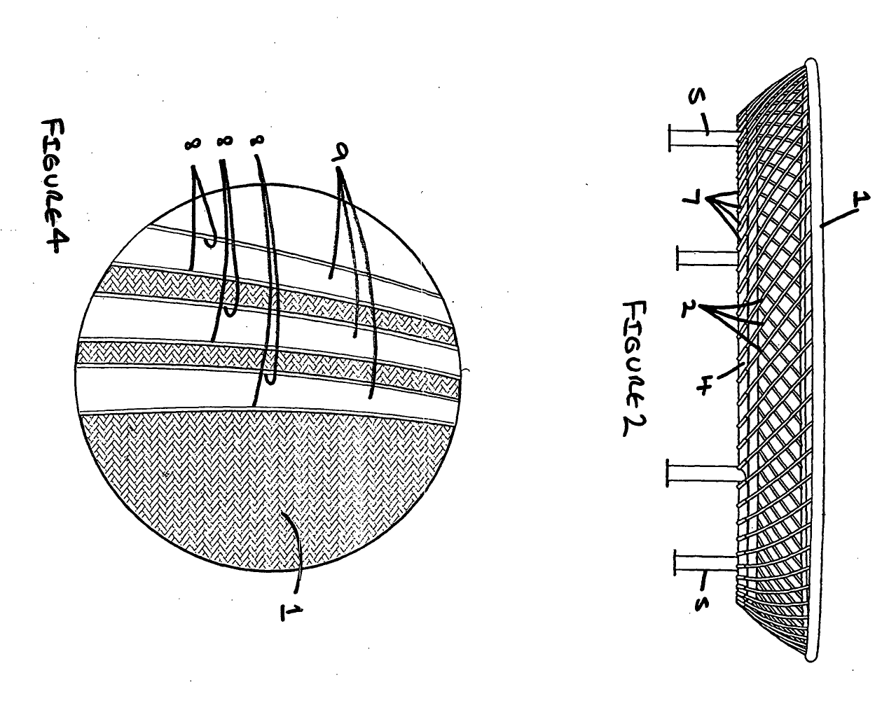

Referring to FIGS. 1 to 3, the preferred form trampoline comprises a flexible mat 1 on which users may bounce, a plurality of resiliently flexible rods 2, and a base frame 3. The preferred form trampoline shown is circular in shape but the trampoline could be of any other desired shape such as oval, square, rectangular or similar.

The base frame of the preferred form trampoline comprises a circular beam 4 typically formed of steel or aluminium for example, which may be supported from the ground by legs 5.

The rods 2 are typically fibreglass rods but may alternatively be formed of spring steel for example. The lower ends of the rods are retained by the base frame 3. The lower ends of the rods are coupled to the circular beam, or a base frame of the trampoline of any other form, in any suitable way. For example the lower ends of the rods 2 may enter into tubular holders 7 fixed to the outside of the circular beam 4 as shown, or alternatively an interior face of the beam 4, or which alternatively again maybe mounted in apertures through the circular beam 4. The upper ends of the rods 2 are coupled to the mat 1 about the periphery of the mat, as described in WO 03/043704 or U.S. Pat. No. 6,319,174 for example, or in any other suitable way. For example the upper ends of the rods may connect to fittings coupled to the peripheral edge the mat. The mat, which is typically heavy canvas or a woven synthetic material, may be doubled back upon itself and fixed by stitching for example about the periphery of the mat to form a continuous pocket extending about the periphery of the mat. Fittings which retain the upper ends of the rods 2 may be loosely captured within the pocket, or alternatively may be stitched to the mat within the edge pocket, or mechanically fastened to the mat via rivets for example.

In accordance with the invention a region of a high visibility colour, contrasting to the colour of the mat, is provided around the peripheral edge of the mat. In the trampoline of FIGS. 1 to 4 the region of contrasting colour is composed of three continuous and concentric lines 9 as shown. Each line may be formed by a circular length of a second material of a colour which is highly contrasting relative to the colour of the mat which is typically a dark colour such as black, fixed to the surface of the mat about the peripheral edge of the mat. The three circular lengths of material are preferably each stitched to the mat by concentric stitch lines 8 as shown in FIG. 4, but in an alternative form may be bonded to the mat by an adhesive for example.

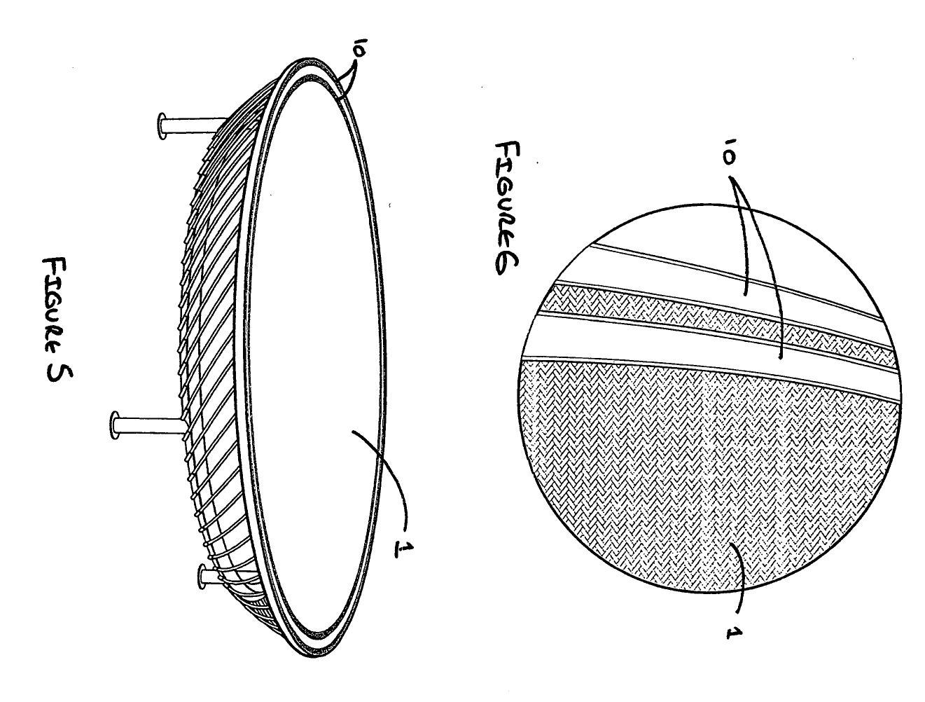

FIGS. 5 and 6 show a trampoline in which the region of contrasting colour is composed of two concentric lines 10, which may again be formed by lengths of material stitched to the upper surface of the mat.

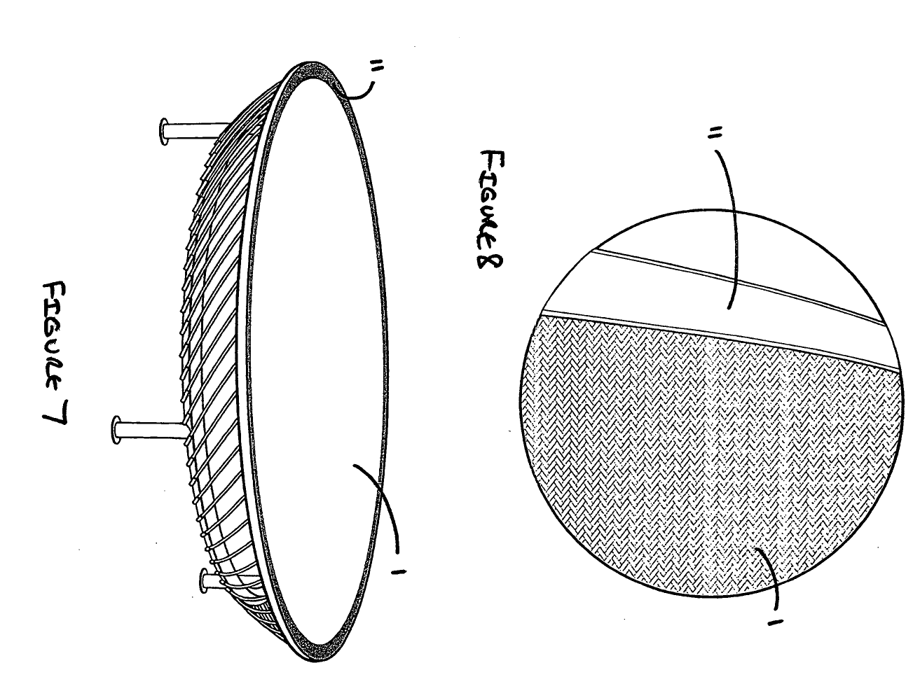

FIGS. 7 and 8 show a trampoline which the region of contrasting colour is formed by a single wider line 11 of a second material preferably stitched about the periphery of the mat, which is in the example shown wider than the individual lines of the embodiments of FIGS. 1 to 4 and 5 to 6.

Preferably the colour of the high visibility peripheral edge of the trampoline is a colour which both contrasts strongly to the colour of the mat itself, and is highly visible. For example where the mat is formed of a material which is black as is typical, the highly contrasting visual edge may be formed in red, yellow, orange, pink or similar. The colour may optionally be an iridescent fluorescent or reflective colour for example where the trampoline matt is light grey for example, the visual edge should be of a colour which is highly visible in contrast to the colour of the mat.

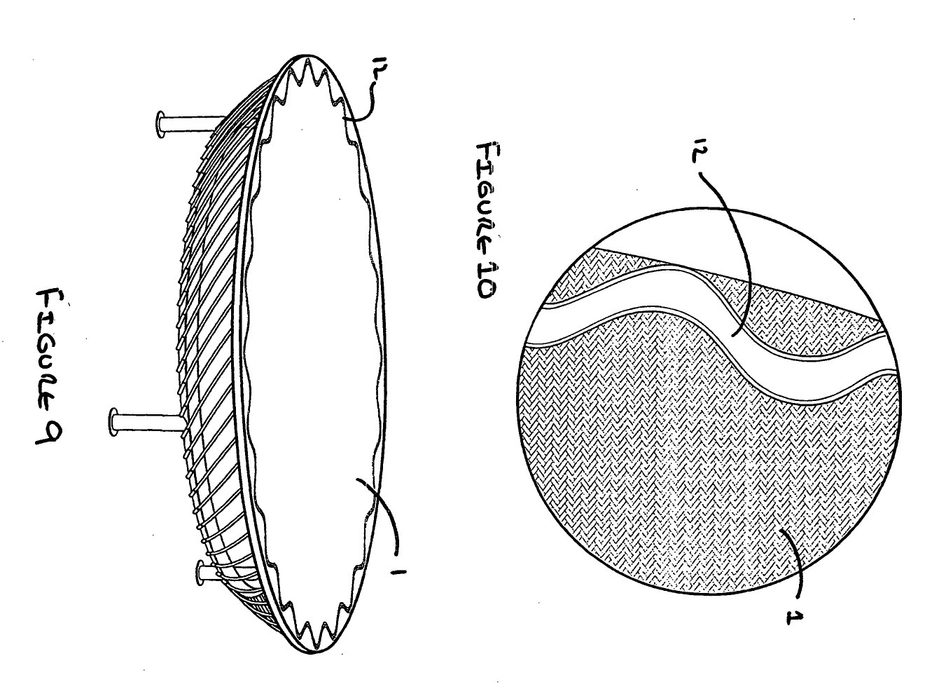

FIGS. 9 and 10 show a further embodiment in which the region of contrasting colour is formed by a single generally sinusoidal line about the periphery of the mat of the trampoline as shown. Instead of a single sinusoidal line 12, two or three parallel or overlapping sinusoidal lines of a contrasting material or colour may be provided.

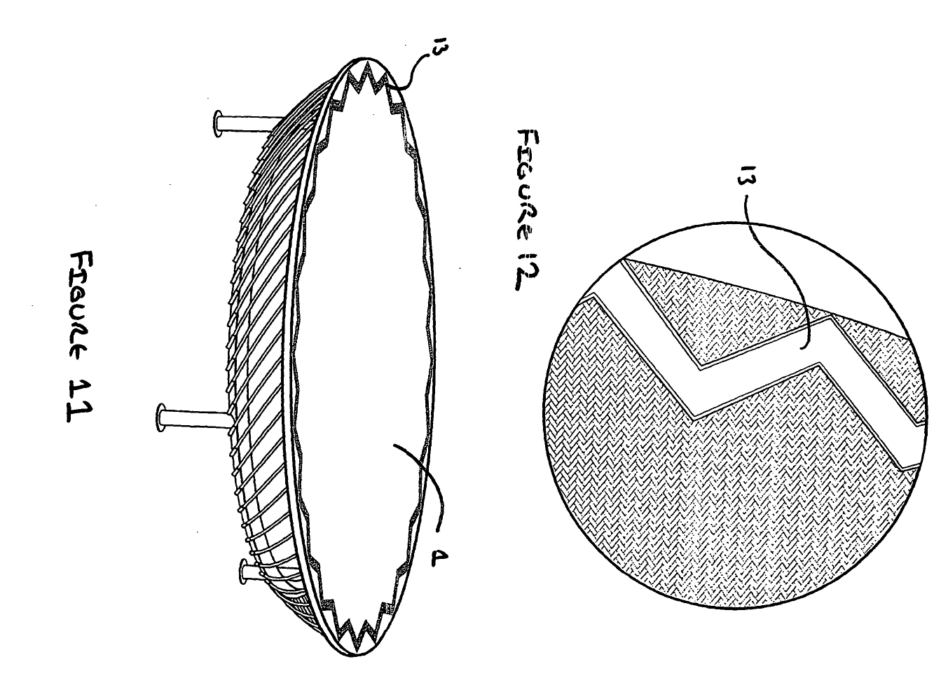

FIGS. 11 and 12 show an embodiment in which the region of contrasting colour is formed a zig-zag line 13. Again two or more zig-zag lines may be provided.

In the embodiments above, the line or lines preferably extend fully around the periphery of the mat as shown. However, the line(s) could have a relatively small break, say for example in the order of 10 mm, between two ends of the line(s). A single stitching process could be used to stitch around the outside of the line, around one end of the line, back around the inside of the line, and around the other end of the line.

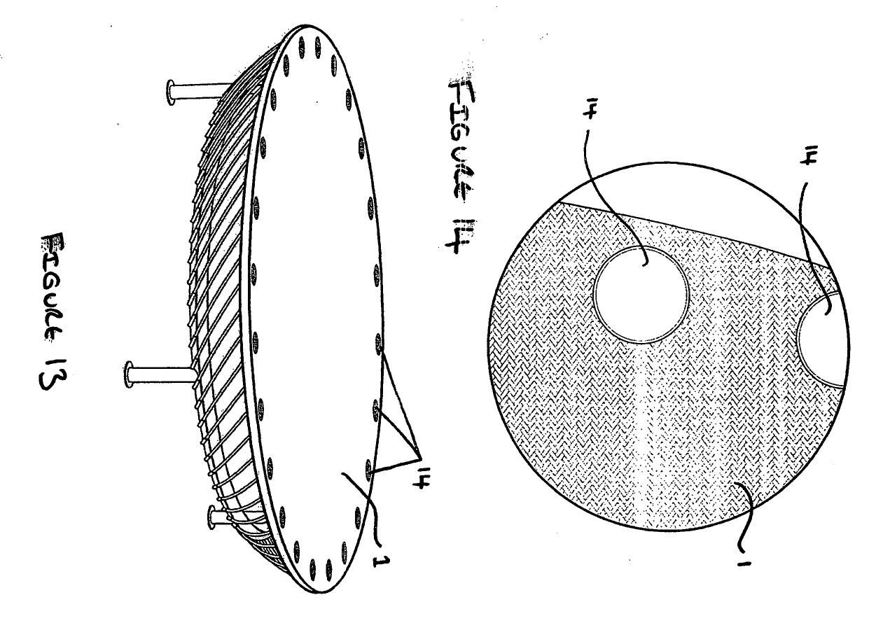

FIGS. 13 and 14 show a further embodiment, in which the region of contrasting colour is formed by discrete non-continuous areas of contrasting colour spaced about the periphery of the mat. A number of discrete pieces of material 14 of colour contrasting to the colour of the mat and which is very preferably a high visibility colour are provided spaced around the periphery of the mat as shown.

While the discrete non-continuous areas shown in FIGS. 13 and 14 are shown as circles, other shapes such as squares, triangles, stars and the like are suitable. Further, letters of the alphabet or numbers could be used, or a plurality of relatively short radial lines could extend inwardly from at or towards the periphery of the mat.

In the embodiments described above the lines or shapes which form the region of contrasting colour are provided by forming them of a second material which is in turn stitched or otherwise fixed to the mat about the periphery of the mat. Alternatively the region of contrasting colour may be provided by painting such high visibility lines or other shapes about the periphery of the mat. Alternatively again the periphery of the mat may be woven with threads or strands of a colour which contrasts to the colour of the balance of the mat, to provide the regions of high visibility colour about the periphery of the mat.

It is common for the mat to have other stitch lines about the periphery of the mat. For example where the mat is doubled back on itself under the mat and stitched to itself to form a pocket extending about the periphery of the mat as referred to previously, in which fittings which retain the upper ends of the flexible rods are contained or captured, then in the embodiments of FIGS. 1 to 7 where the lines or line of contrasting colour are formed by a second material stitched to the top of the mat, it is particularly preferred that a line or at least one of the lines of material is stitched over the top of the stitch line through the mat which forms the pocket about the mat, which serves to protect the stitch line through the mat from UV degradation from sunlight, which extends the life of the mat.

The foregoing describes the invention including preferred forms thereof. Alterations and modifications as will be obvious to those skilled in the art are intended to be incorporated within the scope hereof as defined in the accompanying claims.

1. A trampoline including
a flexible mat,
a plurality of resiliently flexible rods each having a lower end retained in a frame of the trampoline and an upper end coupled to the periphery of the flexible mat, and
a region of contrasting colour to the colour of mat about a peripheral portion of the mat at or adjacent the peripheral edge of the mat.

2. A trampoline according to claim 1 wherein the mat is a relatively darker colour and said region of contrasting colour is a relatively lighter colour.

3. A trampoline according to claim 2 wherein said region of contrasting colour includes a substantially continuous line around said peripheral edge portion of the mat.

4. A trampoline according to claim 3 wherein said region of contrasting colour includes a multiple number of substantially continuous lines around said peripheral edge portion of the mat.

5. A trampoline according to claim 4 wherein said lines are concentric.

6. A trampoline according to claim 3 wherein said line is a zig-zag line around said peripheral edge portion of the mat.

7. A trampoline according to claim 3 wherein said line is an approximately sinusoidal line about said peripheral edge portion of the mat.

8. A trampoline according to claim 1 wherein said region of contrasting colour is an iridescent, fluorescent, or reflective colour.

9. A trampoline according to claim 2 wherein said region of contrasting colour is formed of a different material to the mat, fixed to the upper surface of the mat.

10. A trampoline according to claim 3 wherein said region of contrasting colour is formed of a different material to the mat, fixed to the upper surface of the mat.

11. A trampoline according to claim 2 wherein said region of contrasting colour includes a series of discrete non-continuous areas of contrasting colour spaced around said peripheral edge portion of the mat.

12. A trampoline according to claim 11 wherein said discrete areas of contrasting colour are formed of a different material to the mat, fixed to the upper surface of the mat.

13. A trampoline according to claim 2 wherein said region of contrasting colour is painted onto the peripheral portion of the mat.

14. A trampoline according to claim 2 wherein said region of contrasting colour is formed by elements of contrasting colour woven into the material from which the mat is formed.

15. A trampoline including
a flexible mat
a plurality of resiliently flexible rods each having a lower end retained in a frame of the trampoline and an upper end coupled to the periphery of the flexible mat, and
one or more substantially continuous lengths of high visibility material fixed to the top surface of the mat about the periphery of the mat.

16. A trampoline including
a flexible mat
a plurality of resiliently flexible rods each having a lower end retained in a frame of the trampoline and an upper end coupled to the periphery of the flexible mat, and
a region of high visibility colour about the periphery of the mat.
